(19) United States
(12) Patent Application Publication
(10) Pub. No.: US 2006/0020667 A1
(43) Pub. Date: Jan. 26, 2006

(54) Electronic mail system and method for multi-geographical domains

(75) Inventors: Jui-Ming Wang, Hsindu City (TW); Chung-Sheng Lee, Hsinchu City (TW); Yi-Lung Lien, Hsinchu City (TW); Simon Wang, Taoyuan (TW); Wen-Ta Kuo, Hsinchu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 10/896,833

(22) Filed: Jul. 22, 2004

(51) Int. Cl. G06F 15/16

(52) U.S. Cl. 709/206

(57) ABSTRACT

A method comprises receiving an email message having a sender and at least one recipient at an email server of the sender, determining an address of the at least one recipient's email server closest to the sender's email server, sending the email message to the email server indicated by the address, and forwarding the email message to a mail box of the at least one recipient.

### BACKGROUND

Electronic mail or email is one of the oldest applications on the Internet. Email are text messages that are relayed from one computer to another computer until it reaches its destination. An email message's destination is indicated by the recipient's email address, which is typically in an hierarchical format such as “account_name@domain.com”. The “com” in the email address is a top-level domain that indicates the type of organization that owns the account is a commercial enterprise. Other examples are “edu” for academic institutions, “org” for non-profit organizations, “gov” for government entities, “mil” for military organizations, etc. A two-character country code is also a top-level domain that may be appended to the email address so that the address becomes “account_name@domain.com.tw” for designating an email account owned by a company on Taiwan, for example.

When an email is sent to a recipient, the destination email address is translated into an Internet Protocol (IP) address, which is a unique numerical sequence separated by periods. Using this IP address, the email message is delivered to the destination. The process of translating the email address to an IP address is called domain name resolution and is performed by one or more domain name servers or systems (DNS). A geographical domain name server (GDNS) is used to resolve country-code or geographical level email addresses.

### BRIEF DESCRIPTION OF THE DRAWINGS

References will be made to these drawing figures to help illustrate embodiments of the invention:

FIG. 1 is a simplified schematic diagram of an embodiment of an electronic mail system for multi-geographical domains; and

FIG. 2 is a simplified message flow diagram of an embodiment of an electronic mail method for multi-geographical domains.

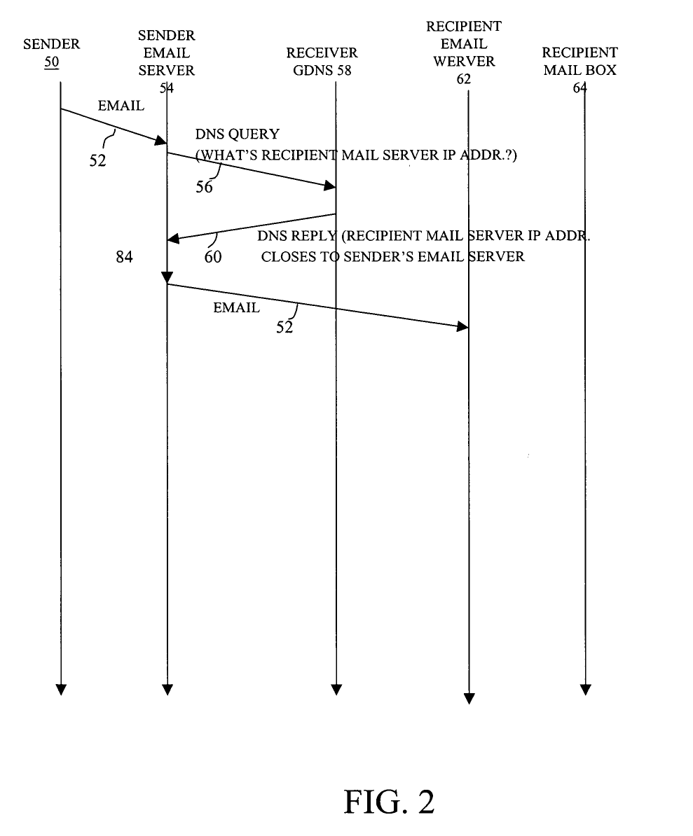

### DETAILED DESCRIPTION

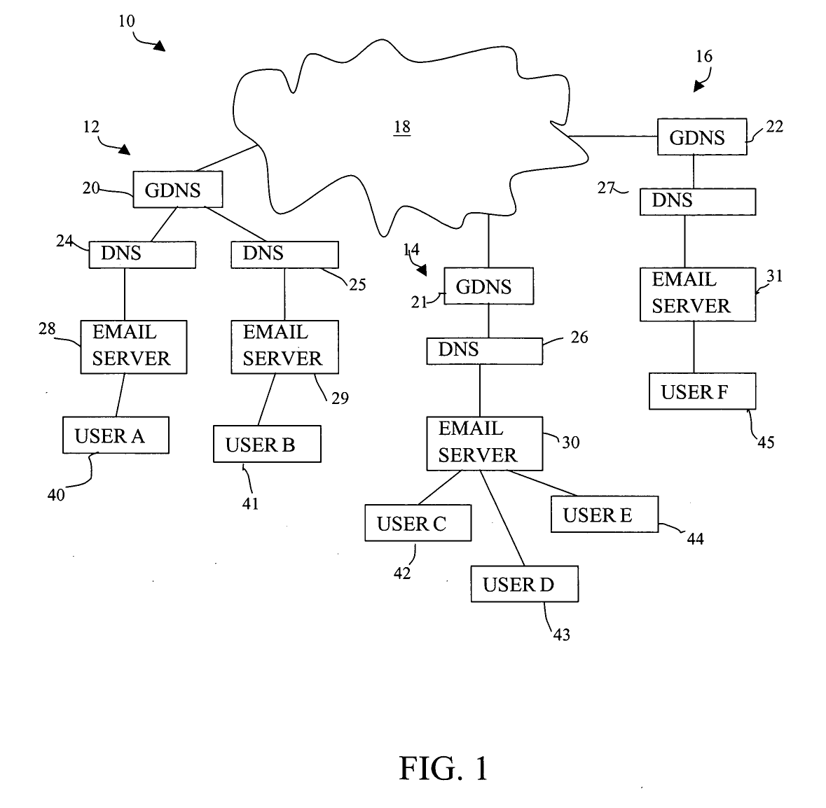

FIG. 1 is a simplified schematic diagram of an embodiment of an electronic mail (email) system 10 spanning multiple geographical domains. FIG. 1 provides an example of an email system 10 and should not be seen as a blue print as the components of system 10 may vary. System 10 encompasses components located in more than one geographical locations 12-16. For the purpose of discussion herein, a geographical location may be a logical designation such as when a country is divided into multiple zones or when a number of countries are grouped into a region. A geographical location may also be a designation according to the political boundaries of a country. A computer network 18 such as the Internet is a communication medium between components residing in different geographical locations 12-16. Computer network 18 may be any other suitable network that enable more than one computers to communicate with one another and its communication paths may be copper, optical, wireless, satellite, and any suitable medium.

In each geographical location 12-16, a geographical domain name server (GDNS) 20-22 resolves geographical-level domain names in a domain name contained in an email address. Geographical domain name servers 20-22 are in communication with their respective lower-level domain name servers (DNS) 24-27. There are typically more than one domain name servers organized in a hierarchical manner in each geographical location. For example, one domain name server may be capable of resolving “com” top-level domain names, and another is capable of resolving “gov” top-level domain names. Other domain name servers may be capable of resolving email addresses of a particular organization, such as “tsmc.com”, for example. These domain name servers are said to be authoritative for resolving their respective domains. Because domain name resolution is done recursively typically using more than one domain name servers, domain name servers 24-27 are used to represent one or more domain name servers used for the domain name resolution process.

A plurality of email servers 28-31 are further in communication with their respective domain name servers 24-27 located at each geographical location. Each email server may have a preferred domain name server with which it typically begins the domain name resolution process. Each email server 28-31 is further in communication with its respective users 40-45 residing in their geographical locations 12-16. For example, email services of USER A 40 are typically furnished by its respective email server 28. In FIG. 1, email servers 28-31 are used to represent one or more types of servers. For example, email servers 28-31 may include Simple Mail Transfer Protocol (SMTP) servers used for processing outgoing email messages and Post Office Protocol (POP) and Internet Message Access Protocol (IMAP) servers used for processing incoming email messages. Users 40-45 may use any suitable communication devices for composing, sending and receiving email messages. For example, users 40-45 may use desktop computers, laptop computers, notebook computers, personal digital assistants, mobile telephones, and other devices now known or later developed.

It should be understood that the links between components in FIG. 1 are not intended to represent or specify direct connections but merely that there are communication paths between the components, direct or indirect. Further, there may be additional communication paths between the components that are not shown for the sake of simplicity and clarity. The communication paths may be copper, optical, wireless, satellite, or any suitable medium now known or later developed.

In conventional systems that use the two-character country code appended to the email address, the country code is used to determine which geographical domain name server services the recipient of the email. Further, when compared to a centralized email system in which emails of a multi-geographical domain enterprise is processed at a centralized server, the method described above is more efficient and faster in delivering the email messages. Delays may result from a bottleneck at the central server. Further, propagation delay may result if the sender and receiver of the email message are located in different geographical locations. Therefore, the delivery of the email message may require more than one cross-geographical boundary crossings.

FIG. 3 is a simplified message flow diagram of an embodiment of an electronic mail method for multi-geographical domains. A sender 50 first sends an email message 52, which is received by the sender's email server 54. The sender's email server 54 sends a domain name server (DNS) query 56 to inquire about the recipient's email server's address to the receiver's geographical domain name server (GDNS) 58. The geographical domain name server 58 of the receiver responds with a DNS reply 60 to the sender's email server 54. The DNS reply 60 contains the IP address of the receiver's email server that is the “closest” to the sender's email server. The term “closest” may denote geographical distance or logically in terms of the ease of communication such as the number of hops between network nodes, for example. Upon receiving the DNS reply 60 from the receiver's GDNS 58, the sender's email server 54 sends the email message 52 to the receiver's email server 62 indicated by the received IP address. The receiver's email server 62 then sends the email message 52 to the receiver's mail box 64.

Although the above description provides illustrative example messages exchanged between the server components, the invention is not so limited. Email message delivery is processed not at a central server, but in a distributed manner at servers associated with the sender of the email. Therefore, processing bottlenecks and delay propagations are avoided. Further, processed in this manner, the two-character country code is also no longer required, which provides for shortened email addresses.

The term “server” is used to refer to any computer or computing devices operable to perform the functions described herein and its use is not intended to limit or specify the implementation of the system and method described herein. Further, although the description references Internet Protocol, the system and method described herein is not limited thereto and is applicable and adaptable to protocols now known or later developed.

What is claimed is:

1. A method comprising:
receiving an email message having a sender and at least one recipient at an email server of the sender;
determining an address of the at least one recipient's email server closest to the sender's email server;
sending the email message to the email server indicated by the address; and
forwarding the email message to a mail box of the at least one recipient.

2. The method, as set forth in claim 1, wherein determining an address comprises determining an IP address of the email server of at least one recipient closest to the sender's email server.

3. The method, as set forth in claim 1, further comprising making at least one DNS query to determine an IP address of the at least one recipient's email server closest to the sender's email server.

4. The method, as set forth in claim 1, wherein determining an address comprises determining an address of the at least one recipient's email server closest in geographical proximity to the sender's email server.

5. The method, as set forth in claim 1, wherein determining an address comprises determining an address of the at least one recipient's email server closest in logical proximity to the sender's email server.

6. A method comprising:
receiving an email message having a sender and at least one recipient at an email server of the sender;
sending a DNS query for an address of the at least one recipient's email server;
receiving a DNS reply including the address of the at least one recipient's email server closest to the sender's email server; and
forwarding the email message to the at least one recipient's email server closest to the sender's email server.

7. The method, as set forth in claim 6, wherein receiving a DNS reply comprises receiving an IP address of the at least one recipient's email server closest to the sender's email server.

8. The method, as set forth in claim 6, wherein receiving a DNS reply comprises receiving an address of the at least one recipient's email server closest in geographical proximity to the sender's email server.

9. The method, as set forth in claim 6, wherein receiving a DNS reply comprises receiving an address of the at least one recipient's email server closest in logical proximity to the sender's email server.

10. The method, as set forth in claim 6, wherein receiving DNS reply comprises receiving an IP address of the at least one recipient's email server closest in proximity to the sender's email server from a GDNS of the at least one recipient.

11. An electronic mail system comprising:
a first email server operable to receive an email message from a sender and process the email message in response to a determination of a geographical location of the sender.

12. The system of claim 11, further comprising a GDNS operable to respond to a DNS query with an address of a second email server closest to the first email server.

13. The system of claim 11, further comprising a GDNS operable to respond to a DNS query with an IP address of a second email server closest to the first email server.

14. The system of claim 11, further comprising a GDNS operable to respond to a DNS query with an IP address of a second email server closest in geographical proximity to the first email server.

15. system of claim 11, further comprising a GDNS operable to respond to a DNS query with an IP address of a second email server closest in logical proximity to the first email server.

16. A computer-readable medium having encoded thereon a method comprising:
receiving a query related to an email message having a sender and at least one recipient received at an email server of the sender;
determining an address of the at least one recipient's email server closest to the sender's email server; and
sending a reply to the query having the address of the at least one recipient's email server closest to the sender's email server.

17. The computer-readable medium, as set forth in claim 16, wherein determining an address comprises determining an IP address of the email server of at least one recipient closest to the sender's email server.

18. The computer-readable medium, as set forth in claim 16, wherein determining an address comprises determining an address of the at least one recipient's email server closest in geographical proximity to the sender's email server.

19. The computer-readable medium, as set forth in claim 16, wherein determining an address comprises determining an address of the at least one recipient's email server closest in logical proximity to the sender's email server.
